(19) United States
(12) Patent Application Publication
(10) Pub. No.: US 2016/0078364 A1
(43) Pub. Date: Mar. 17, 2016

(54) Computer-Implemented Identification of Related Items

(71) Applicant: Microsoft Corporation, Redmond, WA (US)

(72) Inventors: Yu-Hsiang Chiu, Bellevue, WA (US); Xin Yu, Bellevue, WA (US); Arun K. Sacheti, Sammamish, WA (US)

(21) Appl. No.: 14/489,381

(22) Filed: Sep. 17, 2014

(51) Int. Cl. G06N 99/00; G06F 17/30

(52) U.S. Cl. CPC G06N 99/005; G06F 17/30864

(57) ABSTRACT

A computer-implemented training system is described herein for generating at least one model component based on labeled training data. The training system produces the labels in the training data by leveraging textual information expressed in already-evaluated documents. In another implementation, the training system generates a first model component and a second model component. In one implementation, in an application phase, a computer-implemented model-application system applies the first model component to identify an initial set of related items that are related to an input item (such as a query). The model-application system then applies the second model component to select a subset of related items from among the initial set of related items.

### BACKGROUND

Applications sometimes expand an input linguistic item into a set of related linguistic items. For example, a search engine may expand the user's input query into a set of terms that are considered synonymous with the user's input query. The search engine may then perform a search based on the query and the related terms, rather than just the original query. To perform the above task, the search engine may apply a model that is produced in a machine learning process. The machine learning process, in turn, operates on a corpus of training data, composed of a set of labeled training examples. The industry has used different techniques to produce labels for use in the training process, some manual and some automated.

### SUMMARY

A computer-implemented training system is described herein for generating at least one model component. In one implementation, the training system indirectly generates a label for each pairing between a particular seed item (e.g., a particular query) and a particular individual candidate item (e.g., a potential synonym of the query) by leveraging already-evaluated documents. That is, the training system generates the label based on: evaluation measures which measure an extent to which documents in a set of documents have been assessed as being relevant to the particular seed item; and retrieval information which reflects an extent to which the particular candidate item is found in the set of documents.

Overall, the training system generates a model component based on label information and feature information. The label information collectively corresponds to the labels generated in the above-summarized process. The feature information corresponds to sets of feature values generated for the different pairings of seed items and candidate items.

A model-application system is also described herein for applying the model component generated in the above process. The model-application system (e.g., which implements a search service) operates by receiving an input item (e.g., an input query) and applying the model component to generate a set of zero, one, or more related items that are determined, by the model component, to be related to the input item; that set may include or exclude the original input item as a part thereof. The model-application system then generates an output result based on the set of related items, and delivers that output result to an end user.

In another implementation, the training system generates a first model component and a second model component. In the application phase, the first model component identifies an initial set of related items that are related to the input item. The second model component selects a subset of related items from among the initial set of related items.

The above approach can be manifested in various types of systems, devices, components, methods, computer readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of an environment in which a training system produces one or more model components for use by a model-application system (e.g., a search service).

FIG. 2 shows one implementation of the training system of FIG. 1.

FIG. 3 shows one implementation of an item-expansion component, which is a component of the model-application system of FIG. 1.

FIG. 4 shows one computing system which represents an implementation of the overall environment of FIG. 1.

FIG. 5 shows one implementation of a first model-generating component, which is an (optional) component of the training system of FIG. 2.

FIG. 6 is an example of operations performed by the first model-generating component of FIG. 5.

FIG. 7 shows one implementation of a candidate-generating component, which is one component of the first model-generating component of FIG. 5.

FIG. 8 shows one implementation of a label-generating component, which is another component of the first model-generating component of FIG. 5.

FIG. 9 is an example of operations performed by the label-generating component of FIG. 8.

FIG. 10 shows one implementation of a feature-generating component, which is another component of the first model-generating component of FIG. 5.

FIG. 11 shows one implementation of a second model-generating component, which is another (optional) component of the training system of FIG. 2.

FIG. 12 is an example of operations performed by the second model-generating component of FIG. 11.

FIG. 13 shows a process by which the training system of FIG. 1 may generate a model component, such as a first model component (using the model-generating component of FIG. 5) or a second model component (using the second model-generating component of FIG. 11).

FIG. 14 shows a process by which the training system of FIG. 1 may generate labels, for use in producing a model component.

FIG. 15 shows a process by which the training system of FIG. 1 may generate the second model component.

FIG. 16 shows a process which represents one manner of operation the model-application system of FIG. 1.

FIG. 17 shows illustrative computing functionality that can be used to implement any aspect of the features shown in the foregoing drawings.

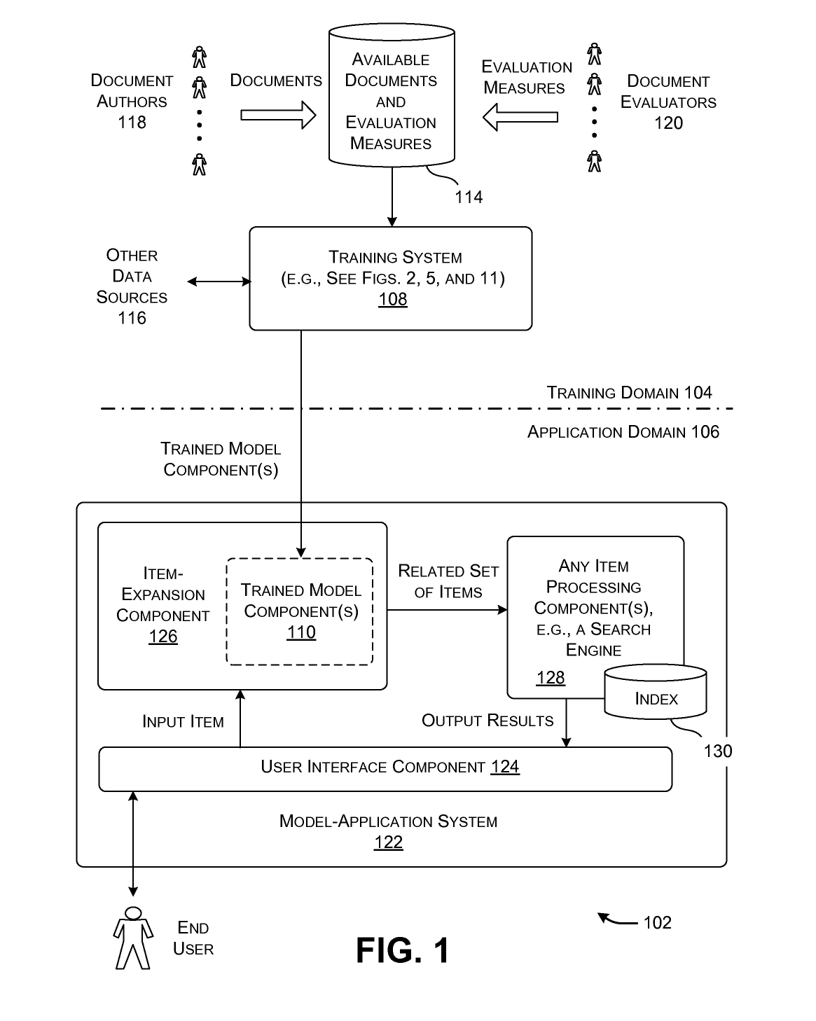

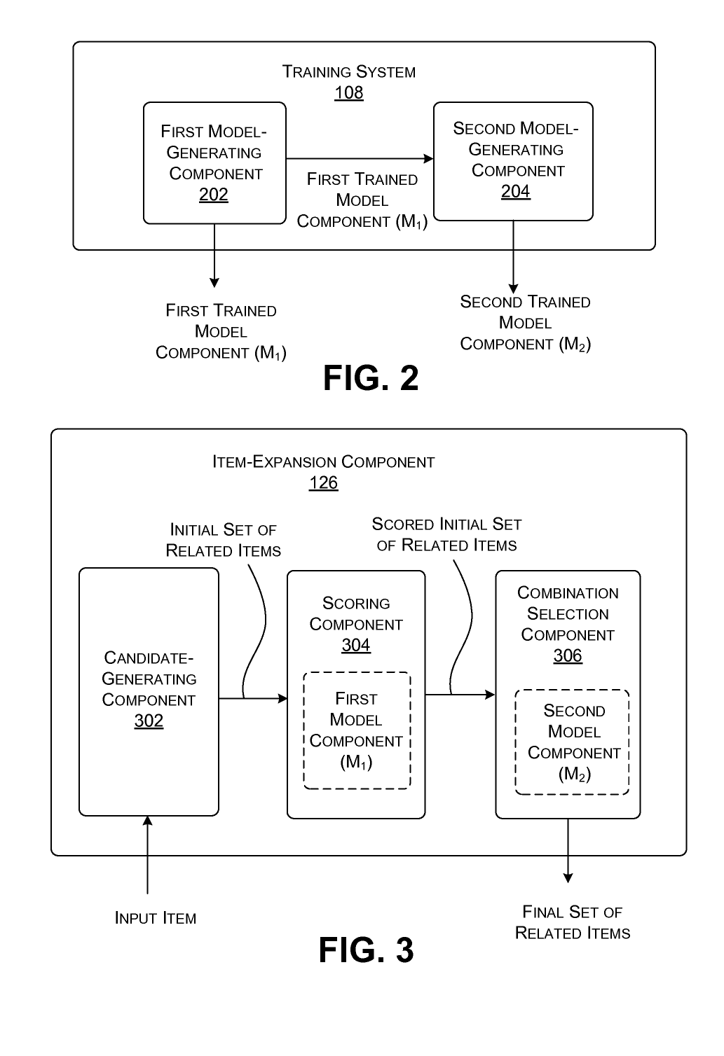

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative environment for generating and applying one or more model components. That is, a training system generates the model component(s), while a model-application system applies the model component(s) to expand an input item into a set of related items. Section B sets forth illustrative methods which explain the operation of the environment of Section A. Section C describes illustrative computing functionality that can be used to implement any aspect of the features described in Sections A and B.

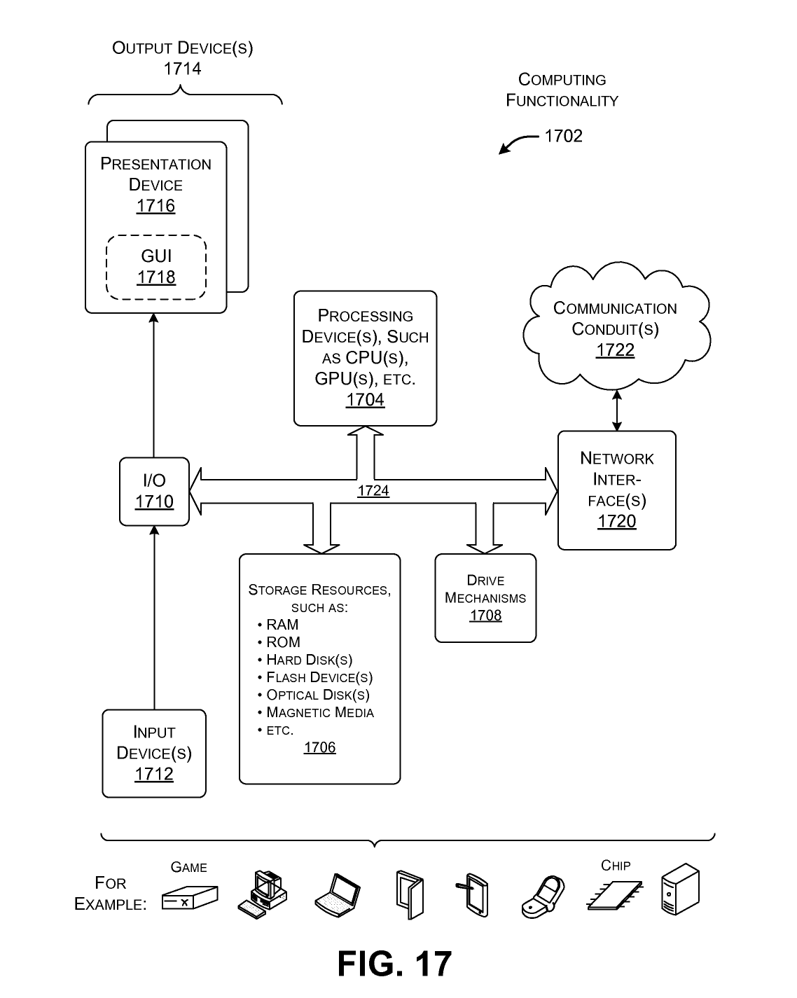

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software running on computer equipment, hardware (e.g., chip-implemented logic functionality), etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 17, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software running on computer equipment, hardware (e.g., chip-implemented logic functionality), etc., and/or any combination thereof.

As to terminology, the phrase “configured to” encompasses any way that any kind of physical and tangible functionality can be constructed to perform an identified operation. The functionality can be configured to perform an operation using, for instance, software running on computer equipment, hardware (e.g., chip-implemented logic functionality), etc., and/or any combination thereof.

The term “logic” encompasses any physical and tangible functionality for performing a task. For instance, each operation illustrated in the flowcharts corresponds to a logic component for performing that operation. An operation can be performed using, for instance, software running on computer equipment, hardware (e.g., chip-implemented logic functionality), etc., and/or any combination thereof. When implemented by computing equipment, a logic component represents an electrical component that is a physical part of the computing system, in whatever manner implemented.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative Environment

A.1. Overview

FIG. 1 shows an environment 102 having a training domain 104 and an application domain 106. The training domain 104 generates one or more model components. The application domain 106 applies the model component(s) in a real-time phase of operation. For example, the application domain 106 may use the model component(s) to expand an input item (e.g., a query) into a set of related items (e.g., synonyms of the query).

The term “item,” as used herein, refers to any linguistic item that is composed of one or more words and/or other symbols. For example, an item may correspond to a query composed of a single word, a phrase, etc. The term “seed item” refers to a given linguistic item under consideration for which one or more related linguistic items are being sought. The term “candidate item” refers to a linguistic item that is being investigated to determine an extent to which it is related to a seed item.

This subsection provides an overview of the environment 102. Subsections A.2 and A.3, to follow, provide additional details regarding individual components within the environment 102.

Starting with the training domain 104, that realm includes a training system 108 for generating one or more model components 110. For example, FIG. 2, described below, shows an example in which the training system 108 produces two model components in two respective phases of a training operation. However, in another example, the training system 108 can produce a single model component in a single training phase.

The training system 108 generates the model component(s) 110 based on a corpus of training examples. For example, the training system 108 may generate a first model component on the basis of a plurality of training examples, each of which includes: (a) a pairing of a particular seed item and a particular candidate item; (b) a label which inferentially characterizes a relationship between the particular seed item and the particular candidate item; and (c) a feature set which describes different characteristics of the particular seed item and/or the particular candidate item. The training system 108 uses at least one label-generating component to determine the labels associated with the training examples. The training system 108 uses at least one feature-generating component to generate the feature sets associated with the training examples. The label-generating component(s) and the feature-generating component(s), in turn, perform their operations based on input data received from different data sources, such as information extracted from documents (provided in one or more data stores 114), and other data sources 116.

The documents in the data store(s) 114 may correspond to any units of information of any type(s), obtained from any source(s). In one implementation, for instance, the documents may correspond to any units of information that can be retrieved via a wide area network, such as the Internet. For example, the documents may include any of: text documents, video items, images, text-annotated audio items, web pages, database records, and so on. Further, any individual document can also contain any combination of content types. Different authors 118 may generate the respective documents.

At least some of the documents are associated with evaluation measures. Each evaluation measure (which may also be referred to as an evaluation score or an evaluation label) describes an assessed relevance of a document with respect to a particular seed item. For example, consider a document that corresponds to a blog entry, which, in turn, corresponds to a discussion about the U.S. city of Seattle. An evaluation measure for that document may describe the relevance of the document to the seed term “Space Needle.” In some cases, the evaluation measure may have a binary value, indicating whether or not the document is relevant (that is, positively related) to the seed item. In other cases, the evaluation measure takes on a value within a continuous range or set of possible values. For example, the evaluation measure may indicate the relevance of the document to the seed item on a scale of 0 to 100, where 0 indicates that the document is not relevant at all, and 100 indicates that the document is highly relevant. Optionally, an evaluation measure could also indicate an extent to which one item is semantically opposed (e.g., negatively related) to another, e.g., by providing a negative score. More generally, as used herein, an assessment of relevance between two items is broadly intended to indicate their relationship, whatever that relationship may be; for example, a measure of relevance may indicate that two items are relevant (e.g., positively related) or not relevant (e.g., not related), and, optionally, the degree of that relationship.

Different preliminary processes may be used to generate the evaluation measures. In one approach, for example, human document evaluators 120 can manually examine the documents, and, for each pairing of a particular seed item and a particular document, determine whether the document is relevant (e.g., positively related) to the seed item. In another case, an automated algorithm (or algorithms) of any type(s) can automatically determine the relevance of a document to a seed item. For example, a latent semantic analysis (LSA) technique can convert the seed item and the document to two respective vectors in a high-level semantic space, and then determine how close these vectors are within that space. In another case, the aggregated behavior (e.g., tagging behavior) of end users can be used to establish the nexus between a seed item and a document, etc. But to facilitate explanation, it will henceforth be assumed that human evaluators 120 supply the evaluation measures.

In some cases, the evaluators 120 may generate the evaluation measures to serve some objective that is unrelated to the use of the evaluation measures in the training domain 104. For example, the evaluators 120 may generate the evaluation measures to provide labels for using in training a ranking algorithm to be deployed in a search engine, rather than to generate the model component(s) 110 shown in FIG. 1. In that case, the training domain 104 effectively repurposes preexisting evaluation measures that have been generated by the document evaluators 120. But in another case, the evaluators 120 may provide the evaluation measures with the explicit objective of developing training data for use in the training domain 104.

Subsections A.2 and A.3 (below) will describe the operation of the label-generating component(s) of the training system 108 in detail. By way of overview here, in generating a first model component, a first label-generating component indirectly generates a label for each pairing between a particular seed item (e.g., a particular query) and a particular candidate item (e.g., a potential synonym of the query) by first identifying a set of documents that have been assessed, by the evaluators 120, for relevance with respect to the particular seed item. For example, assume that the goal is to generate a label for the pairing of a particular seed item, “Space Needle,” and a particular candidate item, “Seattle tower.” The first label-generating component first identifies the set of documents for which evaluation measures exist for the particular seed item under consideration (e.g., “Space Needle”).

The label-generating component then generates the label for the training example based on: the evaluation measures which measure an extent to which documents in the identified set of documents have been assessed as being relevant to the particular seed item (e.g., “Space Needle”); and retrieval information which reflects an extent to which the particular candidate item (e.g., “Seattle tower”) is found in the set of documents. Again, “relevance” broadly conveys a relationship among two items, of any nature. As will be set forth in Subsections A.2 and A.3, the label-generating component(s) can specifically generate the label by computing a recall measure and a precision measure (to be defined below).

Overall, the training system 108 generates the first model component based on label information and feature information, using any computer-implemented machine learning technique. The label information collectively corresponds to the labels generated in the above process for respective pairings of seed items and candidate items. The feature information corresponds to sets of feature values generated for the different pairings of seed items and candidate items.

Now referring to the application domain 106, that functionality includes at least one model-application system 122 for applying the model component(s) 110 generated in the manner described above. The model-application system 122 includes a user interface component 124 for interacting with an end user, such as by receiving an input item (e.g., an input query) submitted by the end user. An item-expansion component 126 uses the model component(s) 110 to generate a set of related items that are determined, by the model component(s) 110, to be related to the input item. In other words, the item-expansion component 126 uses the model component(s) 110 to map the input item into the set of related items.

A processing component 128 performs some action on the set of related items, to generate output results. For example, the processing component 128 may correspond to a search engine provided by a search service. The search engine performs a lookup operation in an index (provided in one or more data stores 130) on the basis of the set of related items. That is, the search engine determines whether each item in the set of related items is found in the index, to provide output results. The user interface component 124 returns the output results to the end user. In a search-related context, the output results may constitute a search result page, providing a list of documents that match the user's input query, which has been expanded by the item-expansion component 126.

In other implementations, the model-application system 122 can perform other respective functions. For example, the model-application system 122 can perform a machine translation function, a mining/discovery function, and so on.

According to one potential benefit, the training system 108 can produce its model component(s) 110 in an efficient and economical manner. More specifically, the training system 108 can eliminate the expense of hiring dedicated experts to directly judge the similarity between pairs of linguistic items. This is because, instead of dedicated experts, the training system 108 relies on a combination of the authors 118 and the evaluators 120 to provide data that can be mined, by the training system 108, to indirectly infer the relationships among pairs of linguistic items. Further, as described above, the documents and evaluation measures may already exist, having been already created by the authors 118 and evaluators 120 with the purpose of serving some other objective. As such, a model developer can repurpose of the information produced by these individuals, rather than paying dedicated workers to perform these tasks.

According to another potential benefit, the training system 108 can produce a training set having relatively high quality using the above process. And because the training set has good quality, the training system 108 can also produce model component(s) 110 having good quality. A good quality model component refers to a model component that accurately and efficiently determines the intent of an end user in submitting an input item (e.g., an input query).

The quality-related benefit of the training system 108 can best be appreciated with reference to alternative techniques for generating training data. In a first alternative technique, a model developer may hire a team of evaluators to directly assess the relevance between pairs of linguistic items, e.g., by asking the evaluators to determine whether the term “Space Needle” is a synonym of “Seattle tower.” This technique has the drawback stated above, namely, that it incurs the cost of hiring dedicated experts. In addition, the work performed by these experts may have varying levels of quality. For example, an expert may not know that the “Space Needle” is a well-known landmark in the Pacific Northwest of the United States; this expert may therefore fail to realize that the terms “Seattle tower” and “Space Needle” are referring to the same landmark. This risk of failure is compounded when an expert for one market domain is asked to make judgments that apply to another market domain, as when a U.S. expert is asked to make judgments regarding an Italian-based market domain.

The training system 108 of FIG. 1 may eliminate or reduce the above type of inaccuracies. This is because the training system leverages the expertise of the authors 118 who have created documents, together with the evaluators 120 who judge the relevance between seed items and documents. These individuals can be expected to produce fewer mistakes compared to the experts in the above-described situation. For example, again consider the author who has written a blog entry about the city of Seattle. That author would be expected to be knowledgeable about the topic of Seattle, else he or she would not have attempted to create a document pertaining to this subject. And the evaluator is in a good position to determine the relevance of a seed term (such as “Space Needle”) to that document, because the evaluator has the entire document at his or her disposal to judge the context in which the comparison is being made. In other words, the evaluator is not being asked to judge the relevance of two terms in isolation. Moreover, in those cases in which the training domain 104 repurposes already-existing evaluation measures that have been developed for the purpose of training some other kind of model component (not associated with the training performed in the training domain 104), there may be a plentiful amount of such information on which to draw, which is another factor which contributes to the production of robust training data.

In a second alternative technique, a model developer may build a model component based on only labels extracted from click-through data. For example, the model developer can consider “Space Needle” and “Space tower” to be related if both of these linguistic items have been used to click on the same document(s). However, this approach can lead to inaccurate labels, and thus, this approach may introduce “noise” into the training data. For example, users may make errant clicks or may misunderstand the nature of the items they are clicking on. Or for certain tail query items, a click log may not have sufficient information to make reliable conclusions regarding the joint behavior of users. The training system 108 of FIG. 1 can eliminate or reduce the above inaccuracies due the manner in which it synergistically leverages the abundantly-expressed expertise of document authors 118 and evaluators 120, in the manner described above.

The production of a high quality model component or components has other consequential benefits. For example, consider the case in which the application domain 106 applies the model components to perform a search. The user benefits from the high quality model component(s) 110 by locating desired information in a time-efficient manner, e.g., because the user may reduce the number of queries that are needed to identify useful information. The search engine benefits from the model component(s) 110 by handling user search sessions in a resource-efficient manner, again due its ability to more quickly identify relevant search results in the course of user search sessions. For instance, the model component(s) 110 may contribute to the efficient use of its processing and memory resources.

The above potential technical benefits are cited by way of illustration, not limitation. Other implementations may offer yet additional benefits.

Advancing now to FIG. 2, this figure shows one implementation of the training system 108 of FIG. 1. In a first case, the model training system 108 uses only a first model-generating component 202 to generate a first model component (M₁). The model-application system 122 may use a candidate-generating component in conjunction with the first model component to map an input item (e.g., a query) into a set of scored related items (e.g., synonyms).

In a second case, the model training system 108 uses the first model-generating component 202 in conjunction with a second model-generating component 204. The first model-generating component 202 generates the above-described first model component (M₁), while the second model-generating component 204 generates a second model component (M₂). As before, the model-application system 122 may use a candidate-generating component and the first model component to map an input item (e.g., a query) into a set of scored related items (e.g., synonyms). The model-application system 122 may then use the second model component to select a subset of the related items provided by the first model component.

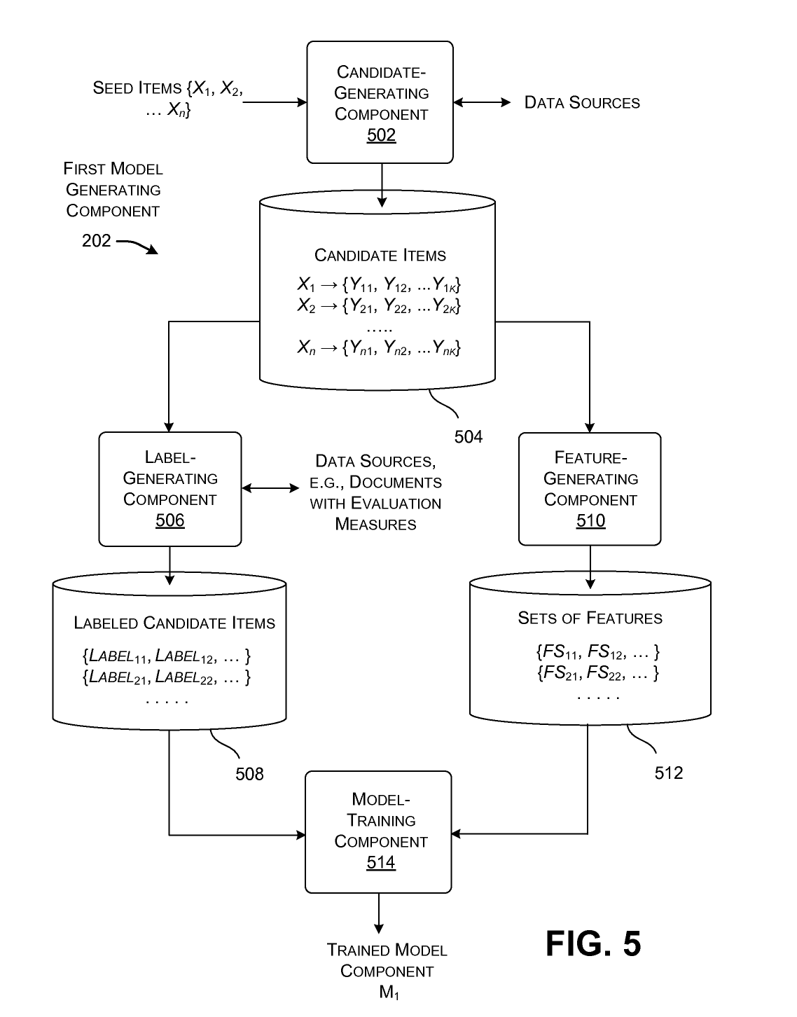

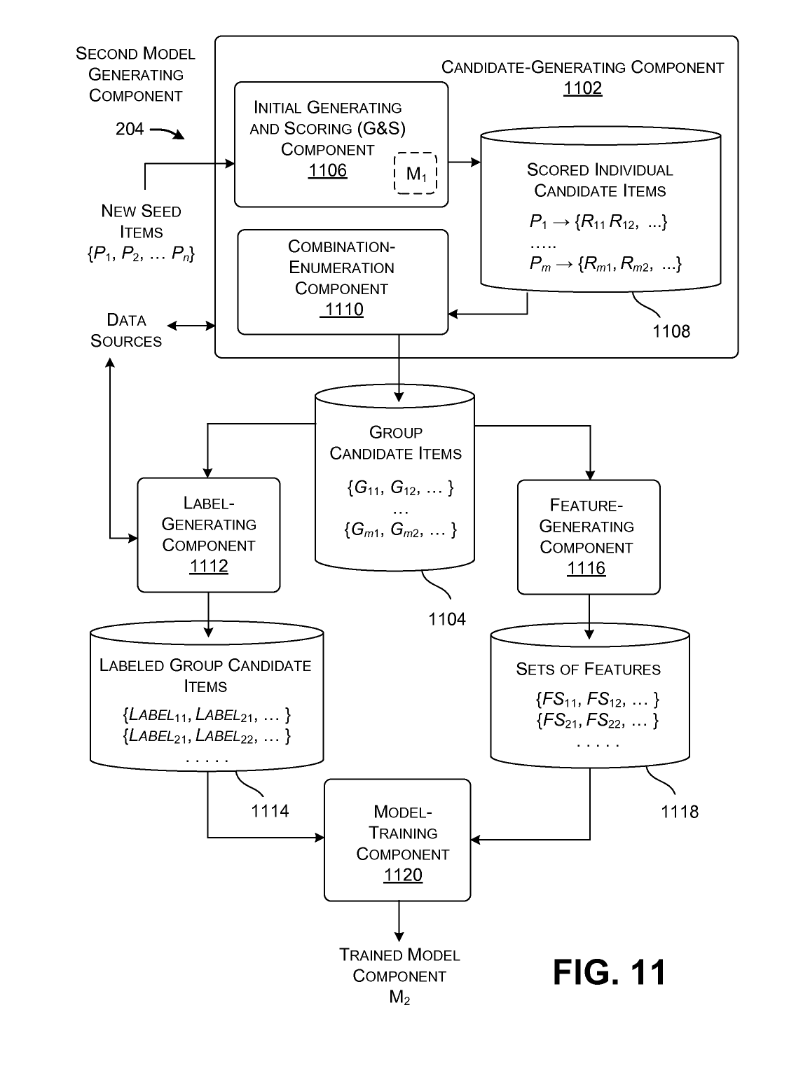

FIG. 2 also shows a line directed from the first model-generating component 202 to the second model-generating component 204. That line indicates that the second model-generating component 204 may use the first model component in the course of generating its training data. The second model-generating component 204 uses a machine learning technique to generate the second model component on the basis of that training data. Overall, FIG. 5 and the accompanying explanation (below) provide further details regarding the first model-generating component 202, while FIG. 11 and the accompanying explanation (below) provide further details regarding the second model-generating component 204.

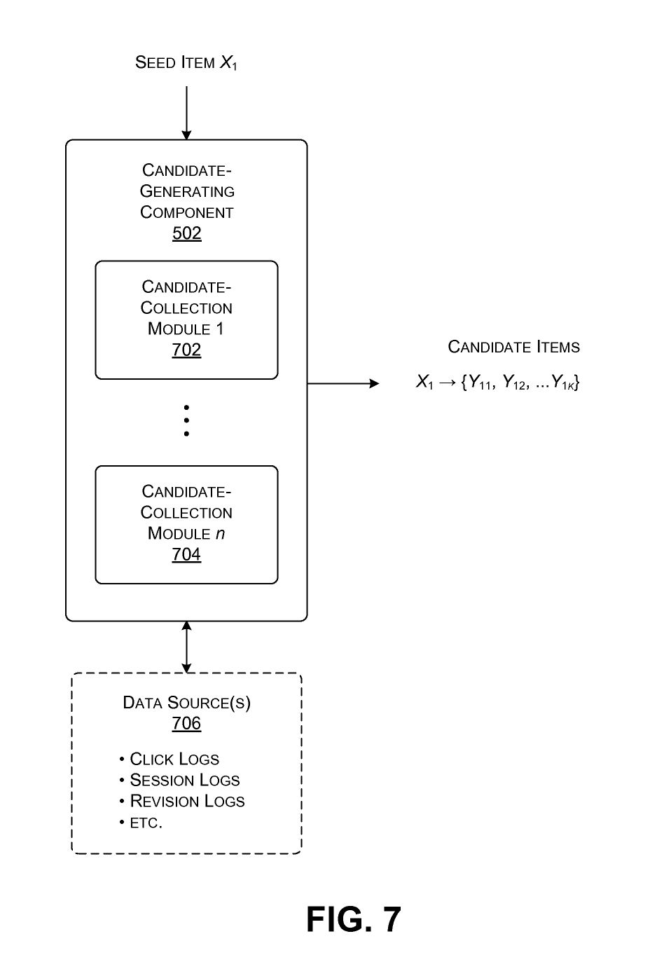

FIG. 3 shows one implementation of the item-expansion component 126, which is a component of the model-application system 122 of FIG. 1. The item-expansion component 126 can include a candidate-generating component 302 for receiving an input item (e.g., an input query), and for generating an initial set of candidate items. FIG. 7 describes one manner of operation of the candidate-generating component 302. By way of overview here, the candidate-generating component 302 can mine plural data sources (such as click logs) to determine candidate items that may be potentially related to the input term.

A scoring component 304 can use the first model component (M₁) to assign scores to the candidate items. More specifically, the scoring component 304 generates feature values associated with each pairing of the input item and a particular candidate item, and then supplies those feature values as input data to the first model component; the first model component maps the feature values into a score for the pairing under consideration.

In one implementation, the output of the scoring component 304 represents the final output of the item-expansion component 126. For example, the processing component 128 (of FIG. 1) can use the top n candidate items identified by the candidate-generating component 302 and the scoring component 304 to perform a search. For example, the processing component 128 can use the top 10 synonyms together with the original query to perform the search.

In another implementation, a combination selection component 306 uses the second model component (M₂) to select a subset of individual candidate items in the scored set of initial candidate items identified by the scoring component 304. More specifically, the combination selection component 306 generates feature values associated with each pairing of the input item and a particular combination of initial candidate items, and then supplies those feature values as input data to the second model component; the second model component then maps the feature values into a score for the pairing under consideration. The processing module 128 (of FIG. 1) can then apply the combination having the highest score to perform a search.

For example, the candidate-generating component 302 and the scoring component 304 may identify fifty individual candidate items. The combination selection component 306 can select a particular combination which represents twenty of these individual candidate items. More specifically, the combination selection component 306 chooses the number of items within the combination, as well as the specific members of the combination, rather than picking a fixed number of top entries, or by picking the entries above a fixed score threshold. In other words, the candidate selection component 306 dynamically chooses the best combination based on the nature of the combination choices under consideration.

Although not shown in FIGS. 2 and 3, other implementations of the training system 108 can generate more than two model components, and other implementations of the item-expansion component 126 can similarly apply more than two model components. The model components may operate by providing analysis in successive stages, and/or in parallel, and/or in any other configuration.

Further note that FIG. 3 illustrates the scoring component 304 (which applies the first model component) and the combination selection component 306 (which applies the second model component) as two discrete units. But the scoring component 304 and the combination selection component 306 may also share common resources, such as common feature-generation logic.

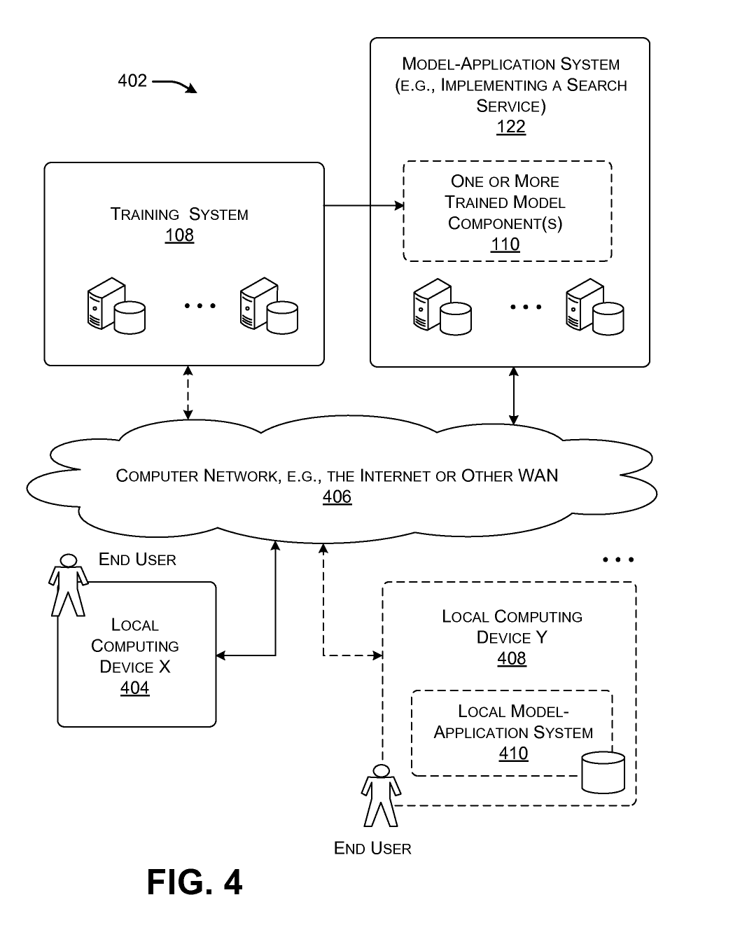

FIG. 4 shows one computing system 402 which represents an implementation of the entire environment 102 of FIG. 1. As shown there, the computing system 402 may implement the training system 108 as one or more server computing devices. Similarly, the computing system 402 may implement the model-application system 122 as one or more server computing devices and/or other computing equipment (e.g., data stores, routers, load balancers, etc.). For example, the model-application system 122 may correspond to an online search service that uses the model component(s) 110 in the process of responding to users' search queries.

An end user may interact with the model-application system 122 using a local computing device 404, via a computer network 406. The local computing device 404 may correspond to a stationary personal computing device (e.g., a workstation computing device), a laptop computing device, a set-top box device, a game console device, a tablet-type computing device, a smartphone, a wearable computing device, and so on. The computer network 406 may correspond to a local area network, a wide area network (e.g., the Internet), one or more point-to-point links, and so on, or any combination thereof.

Alternatively, or in addition, another local computing device 408 may host a local model-application system 410. That local model-application system 410 can use the model component(s) 110 produced by the training system 108 for any purpose. For example, the local model-application system 410 can correspond to a local document retrieval application that uses the model component(s) 110 to expand a user's input query. In that context, an end user can interact with the local model-application system 410 in an offline manner.

A.2. The First Model-Generating Component

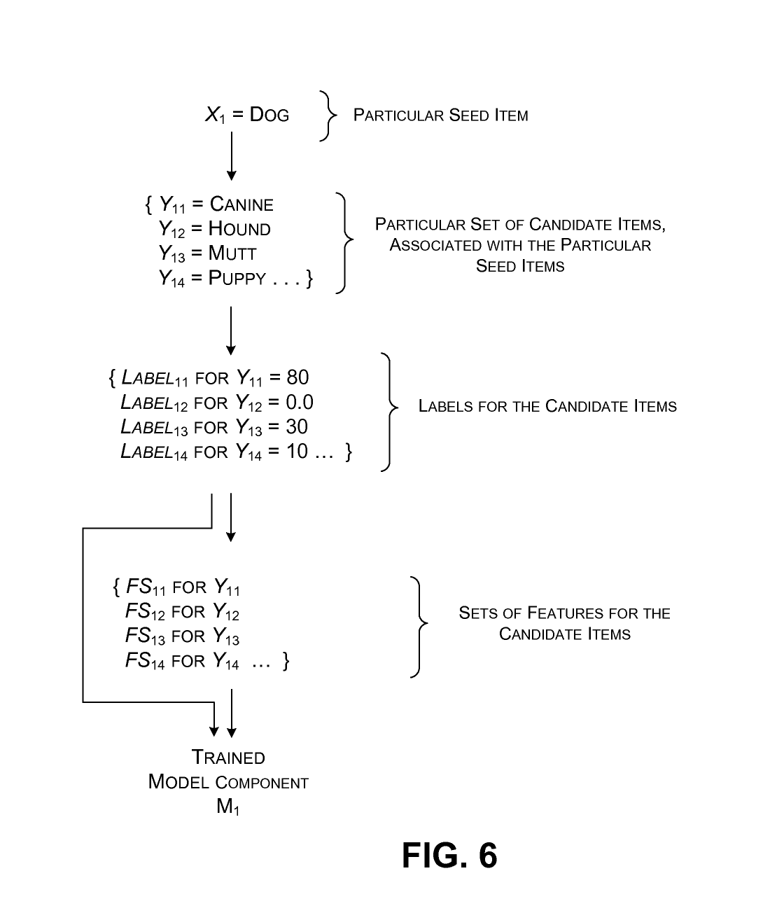

FIG. 5 shows one implementation of the optional first model-generating component 202, introduced in FIG. 2. The purpose of the first model-generating component 202 is to generate a first model component (M₁). The purpose of the first model component, when applied, is to generate a score associated with each pairing of an input item and a particular candidate item. That score describes an extent of the candidate item's relevance (or lack of relevance) to the input item. To facilitate explanation, the first model-generating component 202 will be described in conjunction with the example set forth in FIG. 6. That example presents a concrete instantiation of the concepts of “seed items” and “candidate items,” etc.

A candidate-generating component 502 receives a set of seed items, e.g., {X₁, X₂, . . . Xₙ}. Each seed item corresponds to a linguistic item, composed of one or more words and/or other symbols. The candidate-generating component 502 generates one or more candidate items for each seed item. A candidate item represents a linguistic item that may or may not have a relationship with a seed item under consideration. In the notation of FIG. 5, each candidate item is represented by the symbol Yᵢⱼ, where i refers to the seed item under consideration, and j represents the j^{th} candidate item in a set of K candidate items. One or more data stores 504 may store the seed items and the candidate items.

For example, FIG. 6 shows that one particular seed item (X₁) corresponds to the word “dog.” The candidate-generating component 502 generates a set of candidate items for that word, including “canine” (Y₁₁), “hound” (Y₁₂), “mutt” (Y₁₃), and “puppy” (Y₁₄), etc. The manner in which the candidate-generating component 502 performs this task will be described in connection with the explanation of FIG. 7, below. By way of overview here, the candidate-generating component 502 can mine plural data sources (such as click logs) to determine candidate items that may be potentially related to the term “dog.”

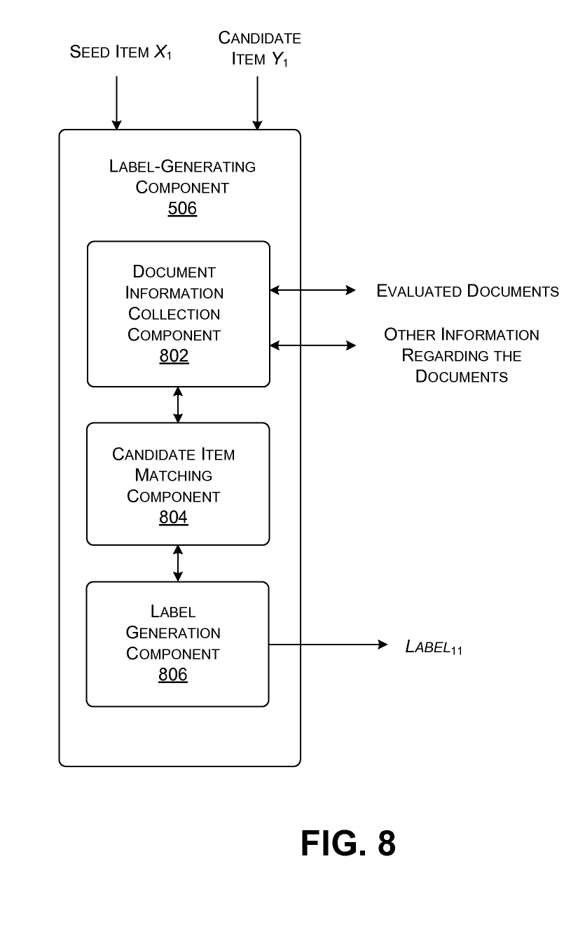

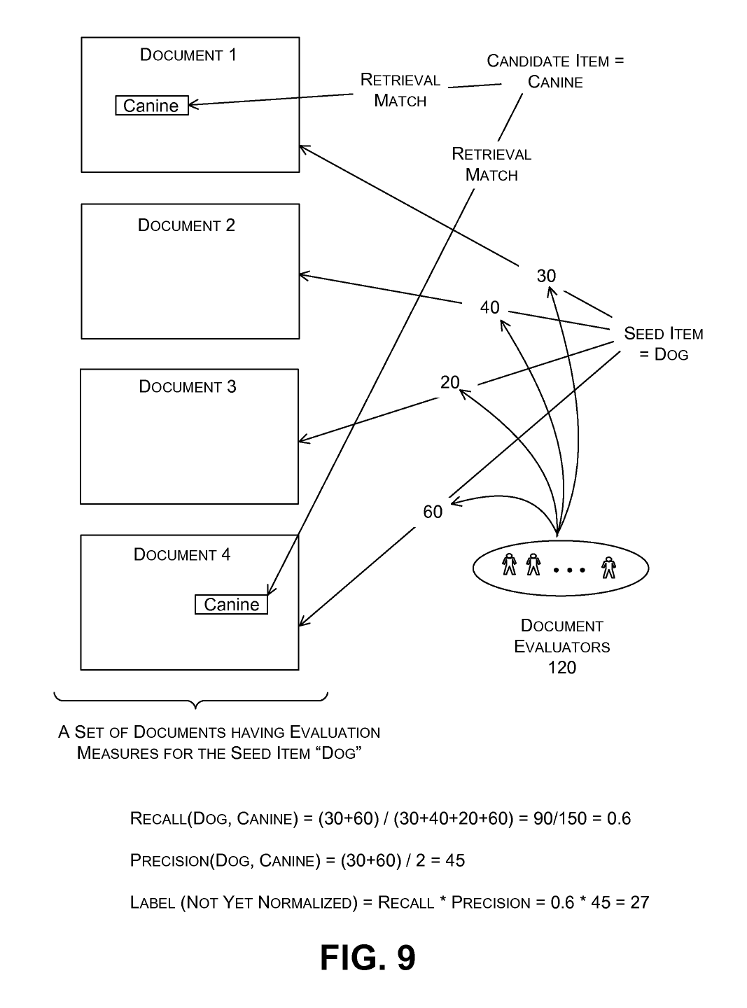

Returning to FIG. 5, a label-generating component 506 assigns a label to each pairing of a particular seed item and a particular candidate item. The label indicates the extent to which the seed item is related to the candidate item. FIGS. 8 and 9 and the accompanying explanation (below) explain one manner of operation of the label-generating component 506. By way of overview, the label-generating component 506 leverages information in documents, together with evaluation measures associated with those documents, to generate its label for a particular pairing of a seed item and a candidate item. The label-generating component 506 may store its output results in one or more data stores 508. Collectively, the labels generated by the label-generating component 506 may be referred to as label information.

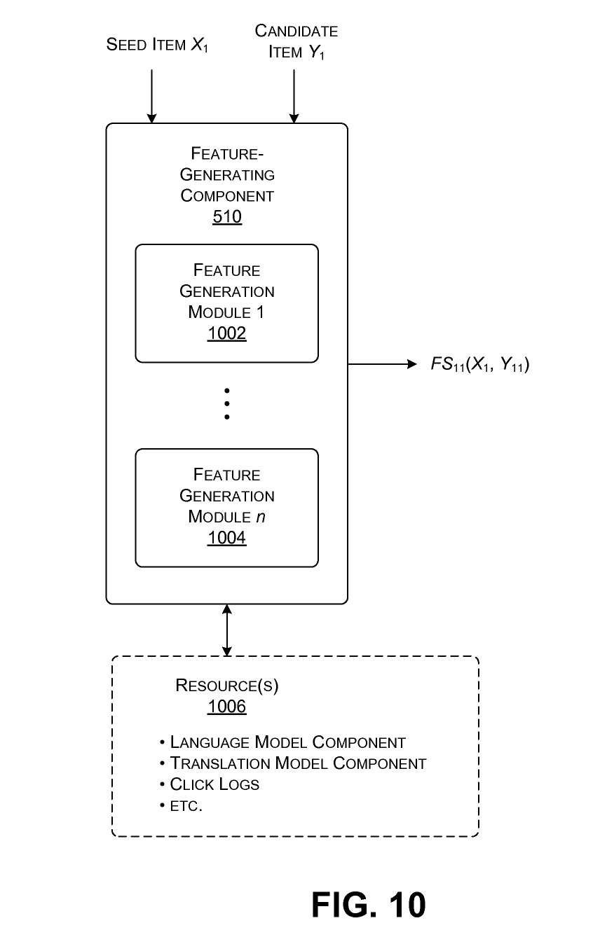

A feature-generating component 510 generates a set of feature values for each pairing of a particular seed item and a particular candidate item. FIG. 10 and the accompanying explanation (below) explain one manner of operation of the feature-generating component 510. By way of overview, the feature-generating component 510 produces feature values which describe different characteristics of the particular seed item and/or the particular candidate item. The feature-generating component 510 may store its output results in one or more data stores 512. Collectively, the feature sets generated by the feature-generating component 510 may be referred to as feature information.

A model-training component 514 generates the first model component (M₁) using a computer-implemented machine learning process on the basis of the label information (computed by the label-generating component 506) and the feature information (computed by the feature-generating component 510). The model-training component 514 can use any algorithm, or combination of computer-implemented algorithms to perform the training task, including, but not limited to any of: a decision tree or random forest technique, a neural network technique, a Bayesian network technique, a clustering technique, etc.

FIG. 6 shows concrete operations that parallel the explanation provided above. As indicated there, the label-generating component 506 generates labels {Label₁₁, Label₁₂, . . . } for the candidate items {Y₁₁, Y₁₂, . . . } (with respect to the seed item X₁), and the feature-generating component 510 generates feature sets {FS₁₁, FS₁₂, . . . } for the candidate items (with respect to the seed item X₁).

FIG. 7 shows one implementation of the candidate-generating component 502 introduced in the context of FIG. 5. (Note that a component of the same name and function is also used in the context of FIG. 3, e.g., in the context of the application of the model component(s) 110 to an input item, such as an input query.) The following explanation of the candidate-generating component 502 will be framed in the context of the simplified scenario in which it generates a set of candidates items {Y₁₁, Y₁₂, Y₁₃, . . . } for a specified seed item (X₁), such as the word “dog” in FIG. 6. The candidate-generating component 502 performs the same function with respect to other seed items.

The candidate-generating component 502 can identify the candidate items using different candidate collection modules (e.g., modules 702, . . . 704); these modules (702, . . . 704), in turn, rely on one or more data sources 706. For example, a first candidate collection module can extract candidate items from a session log. That is, assume that the seed item X₁ is “dog.” The first candidate collection module can identify those user search sessions in which users submitted the term “dog”; then, the first candidate collection module can extract other queries that were submitted in those same sessions. Those other same-session queries constitute candidate items.

A second candidate collection module can extract candidate items from a search engine's click log. A click log captures selections (e.g., “clicks”) made by users, together with queries submitted by the users which preceded the selections. For example, the second candidate collection module can determine the documents that users clicked on after submitting the term “dog” as a search query. The second candidate collection module can then identify other queries, besides the query “dog,” that the users submitted prior to clicking on the same documents. Those queries constitute yet additional candidate items.

A third candidate collection module can leverage a search engine's click log in other ways. For example, the third candidate collection module can identify the titles of the documents that the users clicked on after submitted the query “dog.” Those titles constitutes yet additional candidate items.

The above-described candidate collection modules are set forth in the spirit of illustration, not limitation; other implementations can use other techniques for generating candidate items.

Note that FIG. 7 was framed in the context of the illustrative scenario in which the seed item is a single word, and each of the proposed candidate items is similarly a single word. In other cases, a seed item and its candidate items can each be composed of two or more words. For example, the seed item can correspond to “dog diseases,” and a candidate item can correspond to “canine ailments.” In that scenario, the candidate-generating component 502 can operate in the following illustrative manner.

First, the candidate-generating component 502 can break a seed item (e.g., “dog diseases”) into its component words, i.e., “dog” and “diseases.” The candidate-generating component 502 can then expand each word (that is not a stop word) into a set of word candidate items. The candidate-generating component 502 can then form a final list of phrase candidate items by forming different permutations selected from the words in the different lists of word candidate items. For example, two candidate items for “dog” are “canine” and “mutt,” etc., and two candidate items for “diseases” are “ailments” and “maladies,” etc. Therefore, the candidate-generating component 502 can output a final list of candidates that includes “dog diseases,” “dog ailments,” “dog maladies,” “canine diseases,” “canine ailments,” and so on.

FIG. 8 shows one implementation of the label-generating component 506, introduced in the context of FIG. 5. The label-generating component 506 generates a label for each pairing of a particular seed item (e.g., X₁) and a particular candidate item (e.g., Y₁).

The label-generating component 506 includes a document information collection component (“collection component” for brevity) 802 for identifying a set of documents associated with the particular seed item, e.g., “dog.” The collection component 802 can perform this task by identifying a set of documents that have evaluation measures pertaining to the seed item under consideration, e.g., “dog.”

The collection component 802 can also compile a collection of text items associated with each document. The collection encompasses all of the text items contained in the document itself (or some subset thereof), including its title, section headers, body, etc. The collection component 802 can also extract supplemental text items pertaining to the document, and associate those text items with the document as well. For example, the collection component 802 can identify tags associated with the document (e.g., as added by end users), queries that have been submitted by users prior to clicking on the document, etc. In addition, the document under consideration may be a member of a grouping of documents, all of which are considered as conveying the same basic information. For example, the documents in the grouping may contain the same photograph, or variants of the same photograph. The collection component 802 can extract text items associated with other members in the grouping of documents, such as annotations or other metadata, etc.

A candidate item matching component (“matching component” for brevity) 804 compares a candidate item under consideration with each document, in the set of documents pertaining to the seed item, to determine whether the candidate item matches the text information associated with that document. For example, consider the case in which the candidate item is “canine” (Y₁₁) and the seed item (X₁) is, again, “dog.” The matching component 804 determines whether the document under consideration contains the word “canine.” The matching component 804 can use any matching criteria to determine when two strings match. In some cases, the matching component 804 may insist on an exact match between a candidate item and a corresponding term in the document. In other cases, the matching component 804 can indicate that a match has occurred when two strings are sufficiently similar, based on any similarity metric(s). The result of the matching component 804 is generally referred to herein as retrieval information.

A label generation component 806 determines the label for the pairing of the particular seed item and the particular candidate item on the basis of the evaluation measures associated with the documents (identified by the collection component 802) and the retrieval information (identified by the matching component 804). The label generation component 806 can use different computer-implemented formulas and/or algorithms to compute the label. In one implementation, the label generation component 808 generates the label (label) using the following equation:

label=recall*precision^{r}.

The variable recall, referred to as a recall measure herein, generally describes the ability of the candidate item to match good documents in the set of documents, where a document becomes increasingly “good” in proportion to its evaluation measure. The variable precision, referred to as a precision measure, generally describes how successful the candidate item is in focusing on or targeting certain good documents within the set of documents. The variable r is a balancing parameter which affects the relative contribution of the precision measure in the calculation of the label.

More specifically, in one non-limiting implementation, the label generation component 806 can compute the recall measure by first adding up the evaluation measures associated with all of the documents which match the candidate item (e.g., which match “canine”), within the set of documents that pertain to the particular seed item under consideration (e.g., “dog”). That sum may be referred to as the retrieved gain measure. The label generation component 806 can then add up all evaluation measures associated with the complete set of documents that pertain to the particular seed item under consideration (e.g., “dog”). That sum may be referred to as the total gain available measure. The recall measure is computed by dividing the retrieved gain measure by the total gain available measure.

The label generation component 806 can compute the precision measure by identifying the number of documents in the set of documents which match the candidate item (e.g. “canine”). That sum may be referred to as a documents-retrieved measure. The precision measure is computed by dividing the retrieved gain measure (defined above) by the documents-retrieved measure.

FIG. 9 clarifies the above operations. The collection component 802 first identifies at least four documents that have evaluation measures with respect to the seed item “dog.” That is, for each document, at least one evaluator has made a determination regarding the relevance of the term “dog” to the content of the document. The evaluators 120 may have generated the evaluation measures in some preliminary process, possibly in connection with some task that is unrelated to the objective of training system 108. Assume that evaluators have assigned an evaluation measure of 30 to the first document, an evaluation measure of 40 to the second document, an evaluation measure of 20 to the third document, and an evaluation measure of 60 to the fourth document. For example, each such evaluation measure may represent an average of evaluation measures specified by plural individual evaluators 120.

The matching component 804 next determines those documents that contain the word “canine,” which is the candidate item under consideration. Assume that the first document and the fourth document contain this term, but the second and third documents do not contain this term. As stated above, what constitutes a match between two strings can be defined with any level of exactness, from an exact match to varying degrees of a fuzzy match.

The recall measure corresponds to the sum of evaluation measures associated with the matching documents (e.g., 30+60=90), divided by the sum of the evaluation measures of all four documents (e.g., 30+40+20+60=150). The precision measure corresponds to the sum of evaluation measures associated with the matching documents (again, 90), divided by the number of matching documents (e.g., 2). The label corresponds to the product of the recall measure and the precision measure (here ignoring the contribution of a balancing parameter r, e.g., by assuming that r=1). The label-generating component 506 can also normalize its labels in different ways. For example, without limitation, the label-generating component 506 can multiply each recall measure by 100, and normalize each precision measure so that the permissible range of precision measures is between 0 and 1 (e.g., which can be achieved by dividing the precision measure by the maximum precision measure that has been encountered for a set of candidate items under consideration); as a result of these operations, the label values will fall within the range of 0 to 100.

In other implementations, the label-generating component 506 can be said to more generally generate the label based on the retrieved gain measure, the total gain available measure and the documents-retrieved measure, e.g., according to the following equation:

$$Label = \frac{retrieved gain {measure}^{α}}{total gain available {measure}^{β} * documents retrieved {measure}^{γ}} .$$

Each of α, β, and γ corresponds to an environment-specific balancing parameter. The above equation is equivalent to the first-stated formula when α=1+r, β=1, and γ=r. In yet other implementations, the label-generating component 506 may use a different formula than either of the two above-stated formulas.

The label-generating component 506 can be said to implicitly embody the following reasoning process. First, the label-generating component 506 assumes that the document evaluators 120 have reliably identified the relevance between the seed item (“dog”) and the documents in the set. Second, the label-generating component 506 assumes that the documents with relatively high evaluation measures (corresponding to examples of relatively “good documents”) do a good job in expressing the concept associated with the seed item, and, as a further consequence, are also likely to contain valid synonyms of the seed item. Third, the label-generating component 506 makes the assumption that, if a candidate item is found in many of the good documents and if the candidate item focuses on the good documents with relatively high precision, then there is a good likelihood that the candidate is a synonym of the seed item. The third premise follows, in part, from the first and second premises.

FIG. 10 shows one implementation of the feature-generating component 510, which is another component that was introduced in FIG. 5. The feature-generating component 510 generates a set of feature values for each pairing of a particular seed item (e.g., “dog”) and a particular candidate item (e.g., “canine”). The feature-generating component 510 may use different feature generation modules (1002, . . . , 1004) to generate different types of feature values. The different feature generation modules (1002, . . . , 1004), in turn, can rely on different resources 1006.

For example, a first feature generation module can generate one or more feature values associated with each candidate item by using one or more language model components. For example, for a phrase having the three words A B C in sequence, a tri-gram model component provides the probability of that the word C will occur, considering that the two immediately previous words are A and B. A bi-gram model component provides the probability that the word B will follow the word A, and the probability that word C will follow the word B. A uni-gram model component describes individual frequencies of occurrence of the words, A, B, and C. Any separate computer-implemented process may generate the language model components by computing the occurrences of words within a corpus of text documents.

In one illustrative and non-limiting approach, the first feature generation module can augment each phrase under consideration by adding dummy symbols to the beginning and end of each phrase, e.g., by producing the sequence “<p><p> phrase </p></p>” for a phrase (“phrase”), where “<p><p>” represent arbitrary introductory symbols and “</p></p>” represent arbitrary closing symbols. The phrase itself can have one or more words. The first feature generation module can then run a three-word window over the words in the augmented phrase, and then use a tri-gram model component to generate a score for each three-word combination, where the introductory and closing symbols also constitute “words” to be considered. The first feature generation module can then compute a final language model score by forming the product of the individual language model scores. The first feature generation module can optionally use other language information (e.g., bi-gram and uni-gram scores, etc.), in conjunction with appropriate language model smoothing techniques, in those cases in which tri-gram scores are not available for a phrase under consideration or part of a phrase under consideration.

A second feature generation module can generate one or more feature values associated with a pairing of the seed item and the candidate item using a translation model component. The translation model component generally describes the probability at which items are transformed into other items within a language, and within a particular use context. In one case, any separate computer-implemented process can compute the translation model component based on any evidence of transformations that are performed in a language. For example, the separate process can compute the translation model component by determining the manner in which queries are altered in the course of user search sessions. Alternatively, or in addition, the separate process can compute the translation model component by determining the nexus between queries that have been submitted and document titles that have been clicked on. Alternatively, or in addition, the separate process can compute the translation model component based on queries that have been used to click on the same documents, and so on.

In one implementation, the second feature generation module can compute a translation-related feature value by using the translation model component to determine the probability that the seed item is transformable into the candidate item, or vice versa. For example, the feature value may reflect the frequency at which users have substituted “canine” for “dog” when performing searches, or vice versa.

A third feature generation module generates one or more feature values by determining the text-based similarity between the seed item and the candidate item. The third feature generation module can use any rule or rules to make this assessment. For example, similarity can be assessed based on a number of words that two items have in common, the number of characters that the items have in common, the edit distance between the two items, and so on. The third feature generation module can also generate feature values that describe other text-based characteristics of the seed item and/or the candidate item, such as the number of word in the items, the number of stop words in these items, etc.

A fourth feature generation module generates one or more feature values that pertain to any user behavior that is associated with the seed item and/or candidate item. For example, the fourth feature generation module can formulate one or more feature values which express the extent to which users use the seed item and the candidate item to click on (or otherwise select) the same documents, or different documents, etc. Other behavior-related feature values can describe the frequency at which users submit the seed item and/or the candidate item, e.g., as search terms. Other behavior-related feature values can describe the number of impressions that have been served for a seed item and/or the candidate item, and so on.

The above-described feature generation modules are set forth in spirit of illustration, not limitation; other implementations can use other techniques for generating feature values.

A.3. The Second Model-Generating Component

FIG. 11 shows one implementation of the second model-generating component 204, which is another component of the training system 108. However, as noted above, the training system 108 can optionally omit the use of the second model-generating component 204, e.g., by only using the first model-generating component 202 to compute a single model component. The overall purpose of the second model component (M₂), when applied in the model-application system 122, is to select a subset of individual candidate items that have been identified by the first model component (M₁), from among a plurality of possible combinations of individual candidate items. For that case, the second model-generating component 204 generates the second model (M₂) based on a corpus of training data that has been produced using the first model (M₁). In another case, as will be described below, the second model-generating component 204 can produce the second model component (M₂) on the basis of any other training corpus that has been produced using any type of candidate-generating component, including a candidate-generating component that does not use the first model component (M₁). For that reason, the training system 108 need not use the first model-generating component 202.

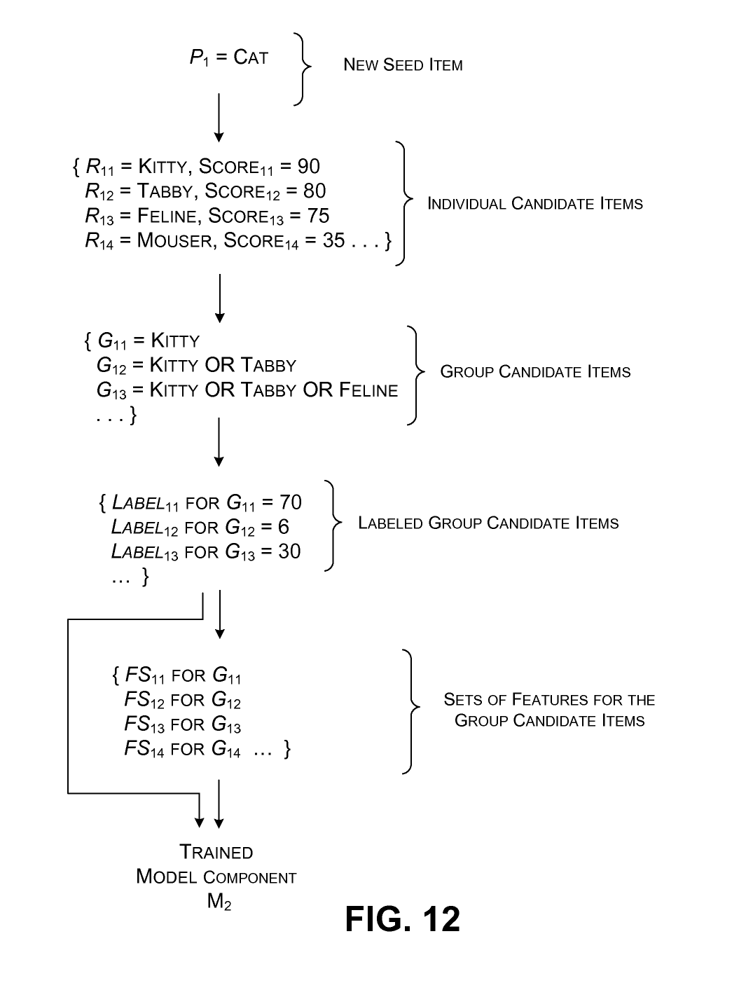

The second model-generating component 204 will be described below in the context of the concrete example shown in FIG. 12. Further, at this stage, assume that the first model-generating component 202 has already generated the first model component (M₁).

The second model-generating component 204 is described as including the same-named components as the first model-generating component 202 because it performs the same core functions as the first model-generating component 202, such as generating candidate items, generating labels, generating feature values, and applying machine learning to produce a model component. But the second model-generating component 204 also operates in a different manner compared to the first model-generating component 202, for the reasons set forth below. In one case, the first model-generating component 202 and the second model-generating component 204 represent two discrete processing engines. But those engines may nonetheless share common resources, such as common feature-generating logic, common machine training logic, and so on. In another case, the first model-generating component 202 and the second model-generating component 204 may represent different instances or applications of the same engine.

To begin with, the second model-generating component 204 uses a candidate-generating component 1102 to generate a plurality of group candidate items. Each group candidate items represents a particular combination of individual candidate items. The candidate-generating component 1102 can store the group candidate items in a data store or stores 1104.

To compute the group candidate items, the candidate-generating component first uses an initial generating and scoring (“G&S”) component 1106 to generate a set of initial candidate items, with scores assigned by the first model component M₁. In operation, the G&S component 1106 first receives a set of new seed input items {P₁, P₂, . . . Pₙ}. These new seed input items can be the same or different compared to the seed input items {X₁, X₂, . . . Xₙ} received by the candidate-generating component 502 of the first model-generating component 202. The G&S component 1106 then generates a set of initial candidate items {Rᵢ₁, Rᵢ₂, . . . } for each new seed input item Pᵢ using the type of candidate-generating component 502 described in FIG. 5. The G&S component 1106 then computes a feature set for each pairing of a particular seed item and a particular initial candidate item. The G&S component 1106 next uses the first model component M₁ to map the feature set into a score for that pairing. In other words, the G&S component 1106 performs the same functions as the candidate-generating component 302 and the scoring component 304 of FIG. 3, but here in the context of generating a training set for use in producing the second model component M₂. A data store (or stores) 1108 may store the scored individual candidate items.

A combination-enumeration component 1110 next forms different combinations of the individual candidate items, each of which is referred to as a group candidate item. For example, the combination-enumeration component 1110 can generate a set of group candidate items {G₁₁, G₁₂, G₁₂ . . . } by generating different arrangements of the individual candidate items {R₁₁, R₁₂, R₁₃, . . . } pertaining to the first new seed item P₁. The combination-enumeration component 1110 can perform this task in different ways. In one approach, the combination-enumeration component 1110 can select combinations of increasing size, incrementally moving down the list of individual candidate items, e.g., by first selecting one item, then two, then three, etc. This manner of operation has the effect of incrementally lowering a threshold that determines whether an individual candidate item is to be included in a combination (that is, based on the score assigned to the candidate item by the first model component). In another approach, the combination-enumeration component 1110 can generate all possible permutations of the set of individual candidate items. Further note that any given group candidate item can represent a combination that includes or excludes the seed item itself For example, it may be appropriate to exclude the seed item in those cases in which it is misspelled, obscure, etc.

Advancing to FIG. 12, assume that one seed item under consideration is the term “cat.” The G&S component 1106 can generate at least four individual candidate items, along with scores, including “kitty” with a score of 90, “tabby” with a score of 80, “feline” with a score of 75, and “mouser” with a score of 35, etc. The combination enumeration component 1110 can then form different combinations of these individual candidate items. For example, a first group can include just the candidate item “kitty,” a second group can include a combination of “kitty” and “tabby,” and a third group can include a combination of “kitty,” “tabby,” and “feline,” etc. Although not shown, the combinations can also include the seed item, namely, “cat.”

Further note that FIG. 12 depicts the simplified case in which each seed item corresponds to a single word, and each individual candidate item likewise corresponds to a single word. But in other cases, the seed items and the candidate items can correspond to respective phrases, each having two or more words and/or other symbols. A candidate item for a phrase may be generated in the same manner described above with respect to FIG. 5.

Returning to FIG. 11, a label-generating component 1112 performs the same core function as the label-generating component 506 of the first model-generating component 202; but, in the context of FIG. 11, the label-generating component 1112 is applied to the task of labeling group candidate items, not individual candidate items. In other words, in one particular implementation, the label-generating component 1112 can compute a recall measure and a precision measure for each group candidate item with respect to a particular seed item (e.g., “cat”), and then form the label as a product of these two measures. A balancing parameter may modify the contribution of the precision measure.

In generating the recall measure and the precision measure, a document is considered to be a match of a group candidate item if it includes any of the elements which compose the group candidate item. For example, assume that the group candidate item corresponds to a combination of “kitty” and “tabby.” A document matches this group candidate item if it includes either or both of the words “kitty” or “tabby.” The label-generating component 1112 can store the labeled group candidate items in one or more data stores 1114. Further note that, as described above, in other implementations, the label-generating component 506 can use other equations to generate its labels, such as the above-stated more general equation (that generates the label based on the retrieved gain measure, the total gain available measure, and the documents-retrieved measure, any one of which may be modified by a balancing parameter).

A feature-generating component 1116 generates a set of feature values for each group candidate item, and stores those feature sets in one or more data stores 1118. Consider a particular group candidate item that groups together a particular combination of individual candidate items. The feature-generating component 1116 generates a collection of feature sets associated with its respective component individual candidate items. For example, consider a group candidate item G₁₃ that encompasses the words “kitty,” “tabby,” and “feline,” and which is associated with the seed item “cat” (P₁). The feature-generating component 1116 generates a first feature set for the pairing of “cat” and “kitty,” a second feature set for the pairing of “cat” and “tabby,” and a third feature set for the pairing of “cat” and “feline.” The feature-generating component 1116 may generate each component feature set in the same manner described above, with respect to the operation of the feature-generating component 510 of FIG. 5, e.g., by leveraging text similarity computations, user behavior data, language model resources, translation model resources, etc.

The feature-generating component 1116 can then form a single set of group-based feature values for each group candidate item, based on any type of group-based analysis of the individual features sets within the group candidate item's collection of feature sets. The feature-generating component 1116 can store the single set of group-based feature values in lieu of the feature sets associated with the individual candidate items.

For instance, the group-based analysis can form statistical-based feature values which provide a statistical summary of the individual feature sets. For example, the final set of feature values can provide minimum values, maximum values, average values, standard deviation values, etc., which summarize the feature values in the group candidate item's component feature sets. For instance, assume that “kitty” has a language score of 0.4, “tabby” has a language score of “0.3,” and “feline” has a language score of “0.2.” For this category of feature values, the feature-generating component 1116 can compute a minimum feature value, a maximum feature value, an average feature value, and/or a standard deviation feature value, and so on. For example, the minimum value is 0.2 and the maximum value is 0.4.

In addition, or alternatively, the group-based analysis can generate other metadata which summarizes the composition of each group candidate item. For instance, consider a group candidate item that is associated with a group of seed item/candidate item pairings; the group-based analysis can identify the number of pairings in the group, the number of words in the group, the number of distinct words in the group, the aggregate edit distance for the group (formed by adding up the individual edit distances between linguistic items in the respective pairings), etc.

Finally, a model-training component applies any type of computer-implemented machine-training technique to generate the second model component (M₂) on the basis of the label information (generated by the label-generating component 1112) and the feature information (generated by the feature-generating component 1116).

In the context of FIG. 12, the label-generating component 1112 generates labels {Label₁₁, Label₁₂, . . . } for the respective group candidate items {G₁₁, G₁₂, . . . }. The feature-generating component 1116 then generates statistical feature sets {FS₁₁, FS₁₂, . . . } for the respective group candidate items. The model-training component 1120 then generates the second model component (M₂) on the basis of the above-described label and feature information.

In a variation of the implementation described above, the second model-generating component 204 (of FIG. 2) can produce the second model component (M₂) on the basis of any other training corpus that has been produced using any other candidate-generating component, including candidate-generating components that do not use the first model component (M₁). For example, a different type of machine-trained model component (besides the model component M₁), and/or some other heuristic or approach, can be used to generate pairs of linguistic items that make up the training corpus. The second model-generating component 204 then operates on that training corpus in the same manner described above to produce the second model component (M₂). Insofar as the training system 108 need not use the first model-generating component 202, the first model-generating component 202 may be considered as an optional component of the training system 108.

Similarly, in the real-time application phase, the combination selection component 306 (of FIG. 3) can receive a set of initial items from some other kind of candidate-generating component (or components), other than the type of the candidate generating component 302 and/or the scoring component 304 described above that specifically uses the model component M₁. The combination selection component 306 otherwise uses the model component M₂ to perform the same operations described above.

B. Illustrative Processes

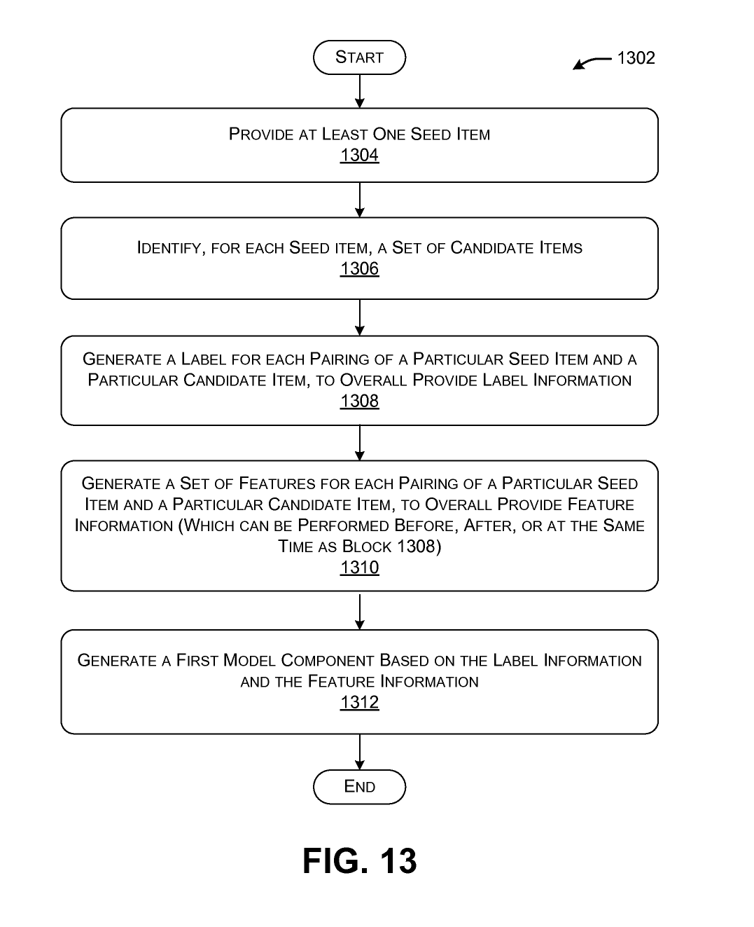

FIGS. 13-16 show processes that explain the operation of the environment 102 of Section A in flowchart form. Since the principles underlying the operation of the environment have already been described in Section A, certain operations will be addressed in summary fashion in this section. The operations in the processes are depicted as a series of blocks having a particular order. But other implementations can vary the order of the operations and/or perform certain operations in parallel.

Starting with FIG. 13, this figure describes a process 1302 which represents one manner of operation of the training system 108 of FIG. 1. More specifically, this figure describes a process by which the training system 108 can generate the first model component (M₁) or the second model component (M₂). In the former case, the first model-generating component 202 uses the process 1302 to operate on individual candidate items, where each individual candidate item includes a single linguistic item (e.g., a single word, phrase, etc.). In the latter case, the second model-generating component 204 uses the process 1302 to again operate on candidate items; but here, each candidate item corresponds to a particular group candidate item that includes a combination of individual candidate items, selected from among a set of possible combinations of the individual candidate items.

To facilitate explanation, FIG. 13 will henceforth be explained with reference to the operation of the first model-generating component 202. In block 1304, the training system 108 provides at least one seed item, such as the word “dog.” In block 1306, a candidate-generating component 502 identifies and stores, for each seed item, a set of candidate items. One such candidate item may correspond to the word “canine.” In block 1308, the label-generating component 506 generates and stores a label for each pairing of a particular seed item and a particular candidate item, to collectively provide label information. In block 1310, the feature-generating component 510 generates and stores a set of feature values for each pairing of a seed item and a candidate item, to collectively provide feature information. In block 1312, the model-training component 514 generates and stores the model component (M₁) based on the label information and the feature information.

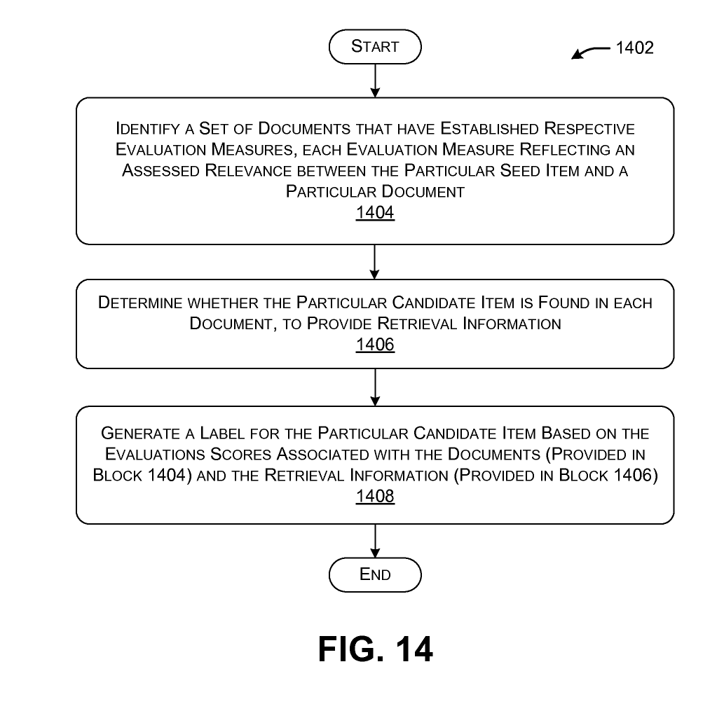

FIG. 14 shows a process 1402 which more specifically describes a label-generation process performed by the label-generating component 506 of FIG. 5, again with respect to the first model-generating component 202. In block 1404, the label-generating component 506 identifies a set of documents that have established respective evaluation measures; more specifically, each evaluation measure reflects an assessed relevance between the particular seed item (e.g., “dog”) and a particular document in the set (e.g., an article about dog grooming). In block 1406, the label-generating component 506 determines whether the particular candidate item (e.g., “canine”) is found in each document, to provide retrieval information. In block 1408, the label-generating component 506 generates a label for the particular candidate item based on the evaluation measures associated with the documents in the set and the retrieval information.

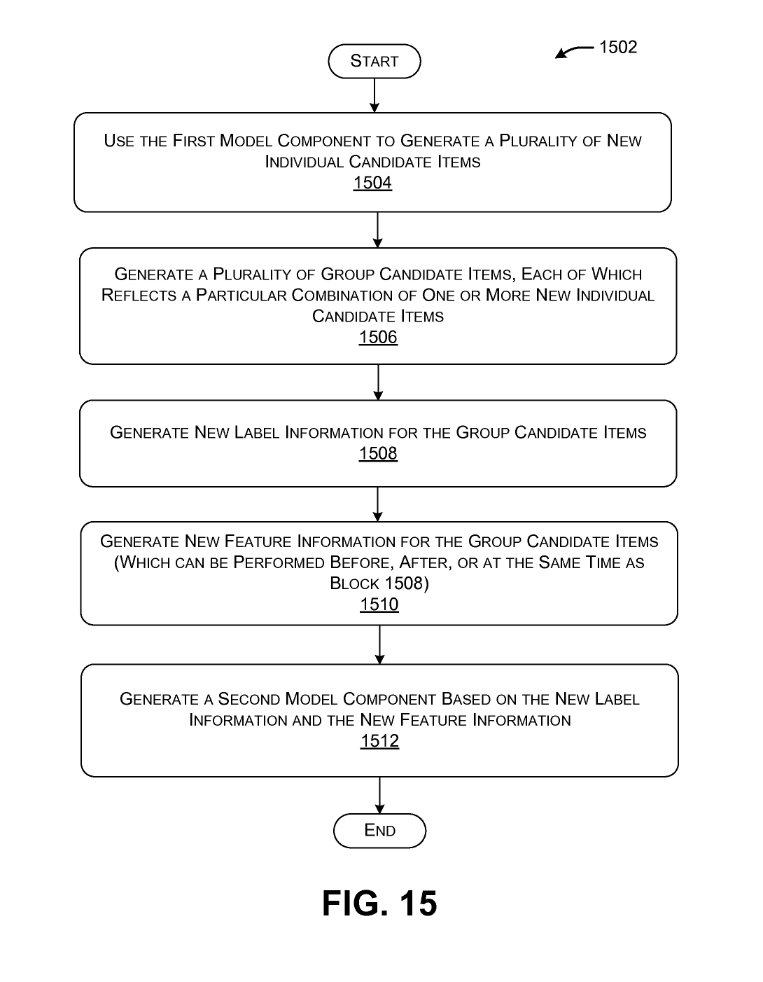

FIG. 15 shows a process 1502 by which the second model-generating component 204 of FIG. 11 may generate a second model component (M₂). In block 1504, the G&S component 1106 uses the first model component (M₁) (and/or some other selection mechanism or technique) to provide a plurality of new individual candidate items, in some cases, with scores assigned thereto. In block 1506, the combination-enumeration component 1110 generates and stores a plurality of group candidate items, each of which reflects a particular combination of one or more new individual candidate items. In block 1508, the label-generating component 1112 generates and stores new label information for the group candidate items. In block 1510, the feature-generating component 1116 generates and stores new feature information for the group candidate items. In block 1512, the model-training component 1120 generates and stores the second model component (M₂) based on the new label information and the new feature information.

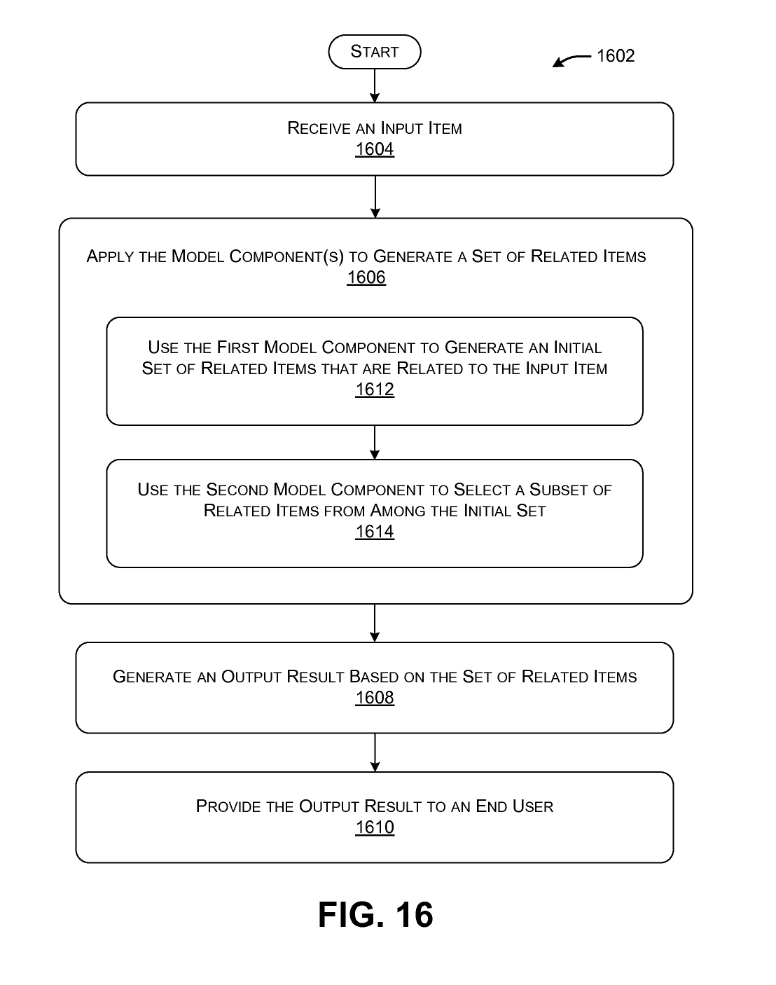

FIG. 16 shows a process 1602 which represents one manner of operation the model-application system 122 of FIG. 1. In block 1604, the model-application system 122 receives and stores an input item, such as an input query from an end user. In block 1606, the item-expansion component 126 can generate and store a set of zero, one, or more related items that represent an expansion of the input item; as used herein, the concept of “a set of related items” is to be broadly interpreted as either including or excluding the original input item as a part thereof. In block 1608, any type of processing component 128 (such as a search engine) generates and stores an output result based on the set of the related items. In block 1610, the model-application system 122 provides the output result to the end user.

The item-expansion component 126 can use different techniques to perform the operation of block 1606. In one approach, in block 1612, some type of mechanism generates an initial set of related items. For example, that mechanisms may correspond to the candidate-generating component 302 in combination with the scoring component 304 (of FIG. 3); in that case, the scoring component 304 uses the first model component (M₁) (and/or some other model component, mechanism, technique, etc.) to provide scores for an initial set of related items. In block 1614, the combination selection component 306 uses the second model component (M₂) to select a particular subset of candidate items from among the initial set of related items. That subset constitutes the final set of related items that is fed to the processing component 128. In other cases, the item-expansion component 126 may omit the operation of block 1614, such that the set of related items that is fed into block 1608 corresponds to the initial set of related items generated in block 1612.

Overall, the model-application system 122 can be said to leverage the use of the model component(s) to facilitate the efficient generation of a relevant output result. For example, in a search context, a relevant output result corresponds to information which satisfies an end user's search intent. The model-application system 122 is said to be efficient, in part, because it may quickly provide a relevant output result, e.g., by eliminating or reducing the need for the user to submit several input items to find the information that he or she is seeking.

In another approach, the item-expansion component 126 can omit the use of the combination selection component 306. Instead, the item-expansion component 126 can use the first model component (M₁) to generate a scored set of candidate items. The item-expansion component 126 can then pick a prescribed number of the top-ranked candidate items. Or the item-expansion component 126 can choose all candidate items having scores above a prescribed threshold. The selected candidate items constitute the related set of items that is fed to the processing component 128.

To summarize the explanations in Sections A and B, according to a first aspect, a computer-implemented method is provided for generating at least one model component. The computer-implemented method uses a training system, that includes one or more computing devices, for: providing at least one seed item; identifying, for each seed item, a set of candidate items; and using a computer-implemented label-generating component to generate a label for each pairing of a particular seed item and a particular candidate item, to collectively provide label information. The label is generated, in turn, using the label-generating component, by: identifying a set of documents that have established respective evaluation measures, each evaluation measure reflecting an assessed relevance between a particular document in the set of documents and the particular seed item; determining whether the particular candidate item is found in each document in the set of documents, to provide retrieval information; and generating the label for the particular candidate item based on the evaluation measures associated with the documents in the set of documents and the retrieval information. The training system further uses a computer-implemented feature-generating component to generate a set of feature values for each pairing of a particular seed item and a particular candidate item, to collectively provide feature information. Finally, the training system uses a computer-implemented model-generating component to generate and store a model component based on the label information and the feature information.

According to a second aspect, a model-application system includes one or more computing devices that operate to: receive an input item; apply the model component to generate a set of zero, one, or more related items that are determined, by the model component, to be related to the input item; generate an output result based at least on the set of related items; and provide the output result to an end user. Overall, the model-application system leverages the use of the model component to facilitate efficient generation of the output result.

According to a third aspect, the operation of identifying the set of candidate items, as applied with respect to the particular seed item, comprises identifying one or more items that have a nexus to the particular seed item, as assessed based on one or more data sources.

According to a fourth aspect, each document, in the set of documents, is associated with a collection of text items, and wherein the collection of text items encompasses text items within the document as well as text items that are determined to relate to the document.

According to a fifth aspect, the operation of generating the label for the particular candidate item comprises: generating a retrieved gain measure, corresponding to an aggregation of evaluation measures associated with a subset of documents, among the set of documents, that match the particular candidate item; generating a total gain available measure, corresponding to an aggregation of evaluation measures associated with all of the documents in the set of documents; generating a documents-retrieved measure, which corresponds to a number of documents, among the set of documents, that match the particular candidate item; and generating the label based on the retrieved gain measure, the total gain available measure, and the documents-retrieved measure.

According to a sixth aspect, the label is generated by multiplying the total gain available measure by the documents-retrieved measure, to form a product, and dividing the retrieved gain measure by the product.

According to a seventh aspect, at least one of the retrieved gain measure, the total gain available measure, and/or the documents-retrieved measure is modified by an exponential balancing parameter.

According to an eighth aspect, the operation of generating the set of feature values, for the pairing of the particular seed item and the particular candidate item, comprises determining at least one feature value that assesses a text-based similarity between the particular seed item and the particular candidate item.

According to a ninth aspect, the operation of generating the set of feature values, for the pairing of the particular seed item and the particular candidate item, comprises determining at least one feature value by applying a language model component to determine a probability of an occurrence of the particular candidate item within a language.

According to a tenth aspect, the operation of generating the particular set of feature values, for the pairing of the particular seed item and the particular candidate item, comprises determining at least one feature value by applying a translation model component to determine a probability that the particular seed item is transformable into the particular candidate item, or vice versa.

According to an eleventh aspect, the operation of generating the particular set of feature values, for the pairing of the particular seed item and the particular candidate item, comprises determining at least one feature value by determining characteristics of prior user behavior pertaining to the particular seed item and/or the particular candidate item.

According a twelfth aspect, the model component that is generated corresponds to a first model component, and wherein the method further comprises: using the training system to generate a second model component; using the model-application system to apply the first model component to generate an initial set of related items that are related to the input item; and using the model-application system to apply the second model component to select a subset of related items from among the initial set of related items.

According to a thirteenth aspect, the training system may generate the second model component by: using the first model component to generate a plurality of new individual candidate items; generating a plurality of group candidate items, each of which reflects a particular combination of one or more new individual candidate items; using another computer-implemented label-generating component to generate new label information for the group candidate items; using another computer-implemented feature-generating component to generate new feature information for the group candidate items; and using another computer-implemented model-generating component to generate the second model component based on the new label information and the new feature information.

According to a fourteenth aspect, each of the set of candidate items (with respect to the first aspect) corresponds to a group candidate item that includes a combination of individual candidate items, selected from among a set of possible combinations, the individual candidate items being generated using any type of candidate-generating component.

According to a fifteenth aspect, the operation of using the feature-generating component to generate new feature information comprises, for each particular group candidate item: determining a set of feature values for each individual candidate item that is associated with the particular group candidate item, to overall provide a collection of feature sets that is associated with the particular group candidate item; and determining at least one feature value that provides group-based information that summarizes the collection of feature sets.

According to a sixteenth aspect, the model-application system implements a search service, the input item corresponds to an input query, and the set of related items corresponds to a set of linguistic items that are determined to be related to the input query.

According to yet another aspect, a method may be provided that includes any permutation of the first through sixteenth aspects.

According to yet another aspect, one or more computing devices may be provided for implementing any permutation of the first through sixteenth aspects, using respective components.

According to yet another aspect, one or more computing devices may be provided for implementing any permutation of the first through sixteenth aspects, using respective means.

According to yet another aspect, a computer readable medium may be provided for implementing any permutation of the first through sixteenth aspects, using respective logic elements.

C. Representative Computing Functionality

FIG. 17 shows computing functionality 1702 that can be used to implement any aspect of the environment 102 set forth in the above-described figures. For instance, the type of computing functionality 1702 shown in FIG. 17 can be used to implement any part(s) of the training system 108 and/or the model-application system 122. In all cases, the computing functionality 1702 represents one or more physical and tangible processing mechanisms.

The computing functionality 1702 can include one or more processing devices 1704, such as one or more central processing units (CPUs), and/or one or more graphical processing units (GPUs), and so on.

The computing functionality 1702 can also include any storage resources 1706 for storing any kind of information, such as code, settings, data, etc. Without limitation, for instance, the storage resources 1706 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 1702. The computing functionality 1702 may perform any of the functions described above when the processing devices 1704 carry out instructions stored in any storage resource or combination of storage resources.

As to terminology, any of the storage resources 1706, or any combination of the storage resources 1706, may be regarded as a computer readable medium. In many cases, a computer readable medium represents some form of physical and tangible entity. The term computer readable medium also encompasses propagated signals, e.g., transmitted or received via physical conduit and/or air or other wireless medium, etc. However, each of the specific terms “computer readable storage medium,” “computer readable medium device,” “computer readable device,” “computer readable hardware,” and “computer readable hardware device” expressly excludes propagated signals per se, while including all other forms of computer readable devices.

The computing functionality 1702 also includes one or more drive mechanisms 1708 for interacting with any storage resource, such as a hard disk drive mechanism, an optical disk drive mechanism, and so on.

The computing functionality 1702 also includes an input/output module 1710 for receiving various inputs (via input devices 1712), and for providing various outputs (via output devices 1714). Illustrative input devices include a keyboard device, a mouse input device, a touchscreen input device, a digitizing pad, one or more video cameras, one or more depth cameras, a free space gesture recognition mechanism, one or more microphones, a voice recognition mechanism, any movement detection mechanisms (e.g., accelerometers, gyroscopes, etc.), and so on. One particular output mechanism may include a presentation device 1716 and an associated graphical user interface (GUI) 1718. Other output devices include a printer, a model-generating mechanism, a tactile output mechanism, an archival mechanism (for storing output information), and so on. The computing functionality 1702 can also include one or more network interfaces 1720 for exchanging data with other devices via one or more communication conduits 1722. One or more communication buses 1724 communicatively couple the above-described components together.

The communication conduit(s) 1722 can be implemented in any manner, e.g., by a local area network, a wide area network (e.g., the Internet), point-to-point connections, etc., or any combination thereof. The communication conduit(s) 1722 can include any combination of hardwired links, wireless links, routers, gateway functionality, name servers, etc., governed by any protocol or combination of protocols.

Alternatively, or in addition, any of the functions described in the preceding sections can be performed, at least in part, by one or more dedicated hardware logic components. For example, without limitation, the computing functionality 1702 can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

In closing, the functionality described herein can employ various mechanisms to ensure that any user data is handled in a manner that conforms to applicable laws, social norms, and the expectations and preferences of individual users.

Further, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for generating and applying at least one model component, comprising:
in a training system that includes one or more computing devices:
providing at least one seed item;
identifying, for each seed item, a set of candidate items;
using a computer-implemented label-generating component to generate a label for each pairing of a particular seed item and a particular candidate item, to collectively provide label information,
the label being generated, using the label-generating component, by:
identifying a set of documents that have established respective evaluation measures, each evaluation measure reflecting an assessed relevance between a particular document in the set of documents and the particular seed item;
determining whether the particular candidate item is found in each document in the set of documents, to provide retrieval information; and
generating the label for the particular candidate item based on the evaluation measures associated with the documents in the set of documents and the retrieval information;
using a computer-implemented feature-generating component to generate a set of feature values for each said pairing of a particular seed item and a particular candidate item, to collectively provide feature information;
using a computer-implemented model-generating component to generate and store a model component based on the label information and the feature information; and
in a model-application system that includes one or more computing devices:
receiving an input item;
applying the model component to generate a set of zero, one, or more related items that are determined, by the model component, to be related to the input item;
generating an output result based at least on the set of related items; and
providing the output result to an end user,
the model-application system leveraging use of the model component to facilitate efficient generation of the output result.

2. The method of claim 1, wherein said identifying of the set of candidate items, as applied with respect to the particular seed item, comprises identifying one or more items that have a nexus to the particular seed item, as assessed based on one or more data sources.

3. The method of claim 1, wherein each document, in the set of documents, is associated with a collection of text items, and wherein the collection of text items encompasses text items within the document as well as text items that are determined to relate to the document.

4. The method of claim 1, wherein said generating of the label for the particular candidate item comprises:
generating a retrieved gain measure, corresponding to an aggregation of evaluation measures associated with a subset of documents, among the set of documents, that match the particular candidate item;
generating a total gain available measure, corresponding to an aggregation of evaluation measures associated with all of the documents in the set of documents;
generating a documents-retrieved measure, which corresponds to a number of documents, among the set of documents, that match the particular candidate item; and
generating the label based on the retrieved gain measure, the total gain available measure, and the documents-retrieved measure.

5. The method of claim 4, wherein the label is generated by multiplying the total gain available measure by the documents-retrieved measure, to form a product, and dividing the retrieved gain measure by the product.

6. The method of claim 4, wherein at least one of the retrieved gain measure, the total gain available measure, and/or the documents-retrieved measure is modified by an exponential balancing parameter.

7. The method of claim 1, wherein said generating of the set of feature values, for the pairing of the particular seed item and the particular candidate item, comprises determining at least one feature value that assesses a text-based similarity between the particular seed item and the particular candidate item.

8. The method of claim 1, wherein said generating of the set of feature values, for the pairing of the particular seed item and the particular candidate item, comprises determining at least one feature value by applying a language model component to determine a probability of an occurrence of the particular candidate item within a language.

9. The method of claim 1, wherein said generating of the particular set of feature values, for the pairing of the particular seed item and the particular candidate item, comprises determining at least one feature value by applying a translation model component to determine a probability that the particular seed item is transformable into the particular candidate item, or vice versa.

10. The method of claim 1, wherein said generating of the particular set of feature values, for the pairing of the particular seed item and the particular candidate item, comprises determining at least one feature value by determining characteristics of prior user behavior pertaining to the particular seed item and/or the particular candidate item.

11. The method of claim 1, wherein the model component that is generated corresponds to a first model component, and wherein the method further comprises:
using the training system to generate a second model component;
using the model-application system to apply the first model component to generate an initial set of related items that are related to the input item; and
using the model-application system to apply the second model component to select a subset of related items from among the initial set of related items.

12. The method of claim 11, wherein the said training system generates the second model component by:
using the first model component to generate a plurality of new individual candidate items;
generating a plurality of group candidate items, each of which reflects a particular combination of one or more new individual candidate items;
using another computer-implemented label-generating component to generate new label information for the group candidate items;
using another computer-implemented feature-generating component to generate new feature information for the group candidate items; and
using another computer-implemented model-generating component to generate the second model component based on the new label information and the new feature information.

13. The method of claim 1, wherein each of the set of candidate items corresponds to a group candidate item that includes a combination of individual candidate items, selected from among a set of possible combinations,
the individual candidate items being generated using any type of candidate-generating component.

14. The method of claim 13, wherein said using of the feature-generating component to generate feature information comprises, for each particular group candidate item:
determining a set of feature values for each individual candidate item that is associated with the particular group candidate item, to overall provide a collection of feature sets that is associated with the particular group candidate item; and
determining at least one feature value that provides group-based information that summarizes the collection of feature sets.

15. The method of claim 1, wherein:
the model-application system implements a search service,
the input item corresponds to an input query, and
the set of related items corresponds to a set of linguistic items that are determined to be related to the input query.

16. A computer readable storage medium for storing computer readable instructions, the computer readable instructions implementing a training system when executed by one or more processing devices, the computer readable instructions comprising:
logic configured to identify, for each of a set of seed items, a set of candidate items;
logic configured to generate a label, for each pairing of a particular seed item and a particular candidate item, based on:
evaluation measures which measure an extent to which documents in a set of documents have been assessed as being relevant to the particular seed item; and
retrieval information which reflects an extent to which the particular candidate item is found in the set of documents;
logic configured to generate a set of feature values for each said pairing of a particular seed item and a particular candidate item,
said logic configured to generate a label collectively providing label information, when applied to all pairings of seed items and candidate items,
said logic configured to generate a set of feature values collectively providing feature information, when applied to all pairings of seed items and candidate items; and
logic configured to generate a model component based on the label information and the feature information,
the model component, when applied by a model-application system, identifying, zero, one, or more related items with respect to an input item,
each particular candidate item corresponding to a particular individual candidate item that includes a single linguistic item, or a particular group candidate item that includes a combination of individual candidate items.

17. The computer readable storage medium of claim 16, wherein said logic configured to generate the label for the particular candidate item comprises:
logic configured to generate a retrieved gain measure, corresponding to an aggregation of evaluation measures associated with a subset of documents, among the set of documents, that match the particular candidate item; and
logic configured to generate a total gain available measure, corresponding to an aggregation of evaluation measures associated with all of the documents in the set of documents;
logic configured to generate a documents-retrieved measure, which corresponds to a number of documents, among the set of documents, that match the particular candidate item; and
logic configured to generate the label based at least on the retrieved gain measure, the total gain available measure, and the documents-retrieved measure.

18. One or more computing devices for implementing at least a training system, comprising:
a candidate-generating component configured to generate a set of candidate items for each seed item, for a plurality of seed items;
a label-generating component configured to generate a label for each pairing of a particular seed item and a particular candidate item, to collectively provide label information,
said label being generated, using the label-generating component, by:
identifying a set of documents that have established respective evaluation measures, each evaluation measure reflecting an assessed relevance between a particular document in the set of documents and the particular seed item;
determining whether the particular candidate item is found in each document in the set of documents, to provide retrieval information; and
generating the label for the particular candidate item based on the evaluation measures associated with the documents in the set of documents and the retrieval information;
a feature-generating component configured to generate a set of feature values for each said pairing of a particular seed item and a particular candidate item, to collectively provide feature information; and
a model-training component configured to generate and store a model component based on the label information and the feature information.

19. The one or more computing devices of claims 18, further comprising a model-application system, implemented by the one or more computing devices, and comprising:
a user interface component configured to receive an input item from an end user;
an item-expansion component configured to apply the model component to generate a set of zero, one, or more related items that are determined, by the model component, to be related to the input item; and
a processing component configured to generate an output result based on the set of related items,
the user interface component further being configured to provide the output result to the end user.

20. The one or more computing devices of claim 19, wherein:
the model component that is generated by the training system corresponds to a first model component,
the training system is further configured to generate a second model component,
the item-expansion component, of the model-application system, is further configured to:
apply the first model component to generate an initial set of related items that are related to the input item; and
apply the second model component to select a subset of related items from among the initial set of related items.
